(19) United States
(12) Patent Application Publication
(10) Pub. No.: US 2015/0332335 A1
(43) Pub. Date: Nov. 19, 2015

(54) INTERACTIVE ADVERTISEMENTS

(71) Applicant: International Business Machines Corporation, Armonk, NY (US)

(72) Inventors: Subil M. Abraham, Plano, TX (US); Praveen B. Dharmavaram, Chantilly, VA (US); Kirtana Raja, Bellaire, TX (US); Mathews Thomas, Flower Mound, TX (US)

(73) Assignee: International Business Machines Corporation, Armonk, NY (US)

(21) Appl. No.: 14/278,719

(22) Filed: May 15, 2014

(51) Int. Cl. G06Q 30/02; G06Q 50/00; H04N 21/81

(52) U.S. Cl. CPC G06Q 30/0269; H04N 21/812; G06Q 30/0245; G06Q 30/0255; G06Q 50/01

(57) ABSTRACT

An advertisement comprising a plurality of video portions in a single video stream can be presented to a user. While the advertisement is being presented in the single video stream, a user feedback indicating at least one of the plurality of video portions that is of interest to the user can be received from the user. The at least one of the plurality of video portions is less than a total of the plurality of video portions of the advertisement. Responsive to receiving the user feedback, an association between the user and the user feedback indicating the at least one of the plurality of video portions of the advertisement that is of interest to the user can be automatically created using a processor. The association between the user and the user feedback can be automatically stored.

### BACKGROUND

Arrangements described herein relate to presentation of an advertisement.

Advertisers are constantly looking for innovative ways to attract consumers to purchase their products. They realize that consumers who have a favorable opinion of their products and/or services are often the best means of promoting their products/services. In this regard, potential consumers are more likely to respond to recommendations of others versus advertisements generated by the advertisers.

### SUMMARY

A method includes presenting, to a first user, an advertisement comprising a plurality of video portions in a single video stream. The method further can include receiving, from the first user, while the advertisement is being presented in the single video stream, a first user feedback indicating at least one of the plurality of video portions that is of interest to the first user, the at least one of the plurality of video portions being less than a total of the plurality of video portions of the advertisement. Responsive to receiving the first user feedback, an association between the first user and the first user feedback indicating the at least one of the plurality of video portions of the advertisement that is of interest to the first user can be automatically created using a processor. The association between the first user and the first user feedback can be automatically stored.

A system includes a processor programmed to initiate executable operations. The executable operations include presenting, to a first user, an advertisement comprising a plurality of video portions in a single video stream. The executable operations further can include receiving, from the first user, while the advertisement is being presented in the single video stream, a first user feedback indicating at least one of the plurality of video portions that is of interest to the first user, the at least one of the plurality of video portions being less than a total of the plurality of video portions of the advertisement. Responsive to receiving the first user feedback, an association between the first user and the first user feedback indicating the at least one of the plurality of video portions of the advertisement that is of interest to the first user can be automatically created. The association between the first user and the first user feedback can be automatically stored.

A computer program includes a computer readable storage medium having program code stored thereon. The program code is executable by a processor to perform a method. The method includes presenting to a first user, by the processor, an advertisement comprising a plurality of video portions in a single video stream. The method further can include receiving, by the processor, from the first user, while the advertisement is being presented in the single video stream, a first user feedback indicating at least one of the plurality of video portions that is of interest to the first user, the at least one of the plurality of video portions being less than a total of the plurality of video portions of the advertisement. Responsive to receiving the first user feedback, an association between the first user and the first user feedback indicating the at least one of the plurality of video portions of the advertisement that is of interest to the first user can be automatically created by the processor. The association between the first user and the first user feedback can be automatically stored by the processor.

### BRIEF DESCRIPTION OF THE SEVERAL VIEWS OF THE DRAWINGS

FIG. 1 is a block diagram illustrating an example of a communication system.

FIG. 2 is a block diagram illustrating example architecture for a data processing system.

FIG. 3 is a flow chart illustrating an example of a method of creating an association between a user and at least one video portion of an advertisement that is of interest to the user.

FIG. 4 is a flow chart illustrating an example of a method of modifying a characteristic of a product in at least one video portion of an advertisement that is of interest to the user.

FIG. 5 is a flow chart illustrating another example of a method of modifying a characteristic of a product in at least one video portion of an advertisement that is of interest to the user.

FIG. 6 is a flow chart illustrating an example of a method of embedding a testimonial, or a link to the testimonial, in at least one video portion of an advertisement that is of interest to the user.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to presenting advertisements and, more particularly, to presenting interactive advertisements. In accordance with the inventive arrangements disclosed herein, an advertisement comprising a plurality of video portions can be presented to a user. User feedback can be received from the user indicating one or more of the video portions (e.g., a portion of the advertisement) that are of interest to the user. An association between the user and the user feedback can be created and stored. For example, a “like” referring to the video portion(s), or a product, service or event promoted by the advertisement can be posted in a social networking service used by the user. The user also can provide a testimonial for the product, service or event, which can be made available when others view the advertisement. For example, the testimonial can be embedded in the advertisement and displayed in a small window while the advertisement is shown, or a link to the testimonial can be embedded within the advertisement. For example, watermarking or fingerprinting techniques can be used to place a marker in the video content stream so that the link will be presented at an appropriate time during playback of the video content.

Further, the user can enter user feedback changing one or more characteristics of a product contained in the advertisement, for example a color of the product, accessories associated with the product, etc., and such feedback can be stored. When the advertisement is again presented to the user or another person, for example a friend of the user, the product can be presented with the changes made by the user. Moreover, when the product is displayed in other video content, for example in a televised sporting event or a movie, the product can be presented to the user and/or the user's friends with the changes made by the user.

Several definitions that apply throughout this document now will be presented.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), an application specific integrated circuit (ASIC) and a controller.

As defined herein, the term “server” means a data processing system comprising at least one processor.

As used herein, the term “display” means an output device that presents visual information. Televisions, tablet computers, laptop computers and smart phones, for example, include displays. A display also can be a discrete device connected to another device or system, for example a computer display (or monitor) or a digital billboard.

As defined herein, the term “user” means a person (i.e., a human being).

As defined herein, the term “advertisement” means a public notice or announcement presented as content via at least one communication medium to promote a product, service, or event. For example, and advertisement may be presented as video content.

As defined herein, the term “video content” means content presented as moving visual images in a video stream. A still image that simply is moved on a display, however, is not a “video content” in the context of the arrangements described herein. Further, an object that is presented on a display, wherein a user manipulates presentation of the object in two or more dimensions, is not a “video content” in the context of the arrangements described herein.

As defined herein, the term “multimedia content” means video content that includes, in addition to moving visual images, audio and/or text. In this regard, video content which is multimedia content may include video and audio, video and text, or video, audio and text.

As defined herein, the term “video stream” means a seamless stream of one or more portions of video content.

As defined herein, the term “user feedback” means a response of a user to information, such as video content, presented to the user.

As defined herein, the term “social networking service” means a communication network based service via which people socially interact with other people in a social network.

As defined herein, the term “testimonial” means an audio, video and/or written statement from a person extolling the virtue of a product, service or event.

As defined herein, the term “communication medium” means a type of transmission channel over which audio, video, audio/video, multimedia, still image and/or web page content is communicated. Examples of a communication medium include, but are not limited to, a television transmission (e.g., via a transmission tower, satellite, cable television system, etc.), a radio transmission (e.g., via a transmission tower, satellite, cable television system, etc.), Internet communication, communication to a digital billboard, and the like.

As defined herein, the term “communication format” means a manner in which audio, video, audio/video, multimedia, still image and/or web page content is encoded for communication via a communication medium.

As defined herein, the term “emotive response” means a response of a user to information, such as audio, video, audio/video, multimedia content and/or still image content, presented to the user, wherein the response indicates an emotion of the user. An emotive response can be, for example, a facial gesture, a body gesture, a hand gesture, and/or the like.

As defined herein, the term “automatically” means without user intervention.

As defined herein, the term “user” means a person (i.e., a human being).

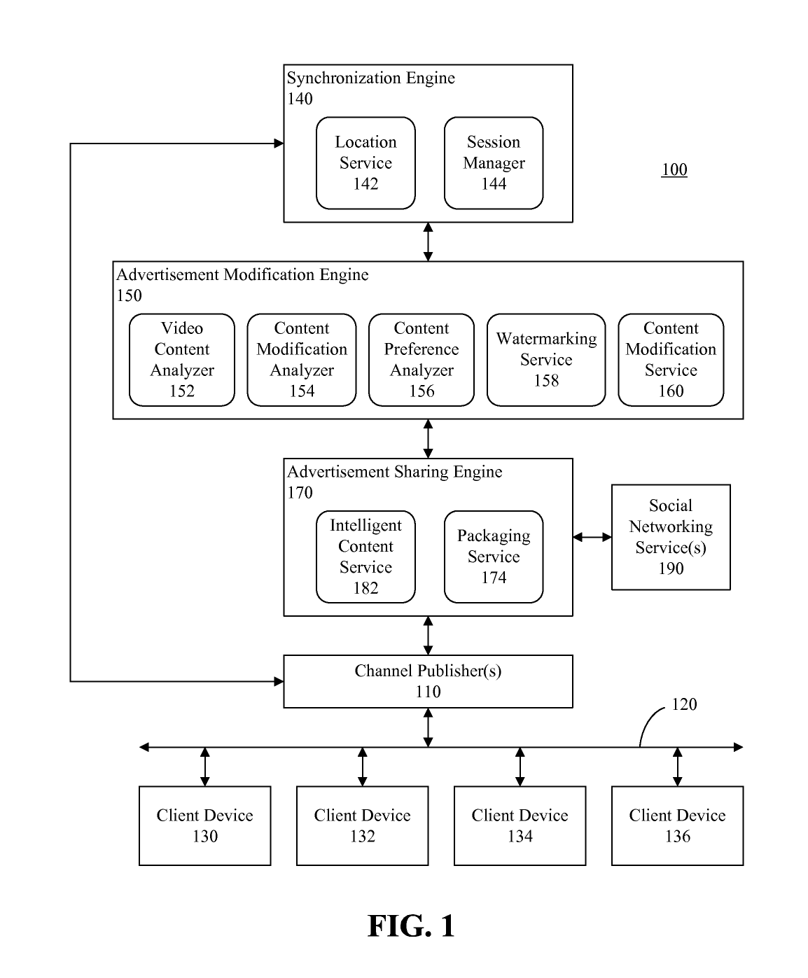

FIG. 1 is a block diagram illustrating an example of a communication system 100 (hereinafter “system 100”). The system 100 can include one or more channel publishers 110 configured to communicate video content to a plurality of users. In this regard, the channel publisher(s) 110 can include one or more processing systems, each including at least one processor, configured to communicate the video content to the plurality of users, as well as perform other channel publishing operations.

The video content can include video or multimedia data, for example television programs, movies, podcasts, Internet based video streams, and the like. Further, some of the video content can be advertisements, as will be described herein. The channel publisher(s) 110 can communicate the video content via one or more communication networks/systems 120 to a plurality of client devices 130, 132, 134, 136 used by the users to view the video content. Examples of the client devices 130-136 include, but are not limited to, televisions, computers (e.g., desktop computers, laptop computers, tablet computers, etc.), smart phones, gaming consoles, set-top boxes, digital television receivers, analog television receivers, displays, digital billboards, and the like. In this regard, the client devices 130-136 each can include, or be operatively connected to, a display. Optionally, one or more of the client devices 130-136 can include, or be operatively connected to, a camera that detects images/video of one or more users and/or a microphone that detects audio generated by one or more users.

The communication networks/systems 120 provide various communication mediums via which the channel publisher(s) 110 communicate video content to the client devices 130-136. The communication networks/systems 120 may include connections, such as wire, wireless communication links, or fiber optic cables, as well as equipment well known in the art for delivering content. In this regard, the communication networks/systems 120 can be implemented as, or include, any of a variety of different communication technologies, for example television transmitters, television delivery satellites, wired television delivery systems, digital imaging systems, wide area networks (WANs), local area networks (LANs), wireless networks, mobile networks, Virtual Private Networks (VPNs), the Internet, the Public Switched Telephone Network (PSTN), and the like.

The system 100 also can include a synchronization engine 140, an advertisement modification engine 150 and an advertisement sharing engine 170. In one arrangement, the synchronization engine 140, advertisement modification engine 150 and advertisement sharing engine 170 each can be executed on one or more respective processing systems (e.g., servers), each processing system including at least one processor, and the respective processing systems can be communicatively linked via one or more communication networks/systems, such as those previously described. In another arrangement, the synchronization engine 140, advertisement modification engine 150 and advertisement sharing engine 170 together can be executed on the same processing system or one or more shared processing systems. Further, the synchronization engine 140 and the advertisement sharing engine 150 can be communicatively linked to the channel publisher(s) 110 via one or more communication networks/systems, such as those previously described.

The synchronization engine 140 can include a location service 142 and a session manager 144. The location service 142 can detect a user's use of a particular communication medium through a variety of ways. For example, the location service 142 can detect the user logging into one or more applications or using one or more subscription content services (e.g., satellite television, cable television, etc.), detect one or more client devices 130-136 being turned on, detect IP and/or media access control (MAC) addresses of the client devices 130-136, detect remote control (e.g., television remote control), selections detect a physical location and/or physical movement of the user (e.g., detect presence of the user in front of a television, detect the user being logged into a computer or smart phone, and the like). The location service 142 can implement various technologies to detect such information, for example a global positioning system (GPS), user login systems, camera's and/or other detection equipment associated with the client devices 130-136, obtaining a user's location from a cellular communication provider, and the like. In one aspect, the location service can use multiple technologies to determine a location of a user. For example, if the user's location is indicated by a GPS system or the user's cellular communication provider as the user's home, and the user's television is turned on, the location service 142 can estimate that the user is in front of the user's television, and use this estimate as the determined location. Once the location has been determined, location information can be presented to the session manager 144. In addition, the information can be communicated to the advertisement modification engine 150, which will be described, to help determine the best mode of delivery of advertisements to the user.

The session manager 144 can maintain and control the application of user information and user preference data pertaining to advertisements, channels accessed by users for viewing video content, etc. Further, the session manager 144 can store advertising preferences for the user. For example, the session manager 144 can include a user interface via which the user can interact via a client device 130-136 to input the user's advertisement preferences, indicate communication formats and/or communication mediums via which the user chooses to receive advertisements and/or other video content, indicate a nature of advertisements acceptable to the user (e.g., only advertisements suitable for children to view/listen, advertisements suitable for teenagers to view/listen and/or advertisements containing adult content), and the like. The session manager 144 also can store data related to the actual length of particular advertisements, and user preferences regarding user desired length of advertisements. Accordingly, the session manager 114 can ensure that advertisements presented to users comply with user expectations.

Moreover, users can specify their interests in advertisement and other video content and/or such user interests can be detected by monitoring user actions, for example using a camera, microphone or the like. In illustration, if a user is paying close attention to certain advertisements, to certain portions of the advertisements and/or to certain portions of the screen where a certain image is shown (e.g., an image of shoes being advertised), such action by the user can be received as user feedback indicating a level of interest by the user in the advertisement, a portion of the advertisement, or a product or service represented by the advertisement. The user also can point to certain parts of the screen to express interest, for example using a cursor or by pointing an appendage (e.g., finger) at a certain part of the display on which the advertisement is presented. A user also can select a “like” or “dislike” button presented on the display, for example in or near video content (e.g., an advertisement) to selectively like or dislike one or portions of the video content, select a share button presented in or near the video content, or enter comments into an appropriate field presented in or near the video content. Accordingly, feedback from the user can be obtained by the session manager 144, via the client devices 130-136 and channel publisher(s) 110, to indicate user interest in video content, indicate user interest in one or more portions of video content, indicate a user preference to share one or more portions of the video content, and the like.

In this regard, an advertisement presented to a user in a single video stream can include a plurality of video portions, and the user can provide user feedback that indicates one or more of the video portions, which are less than a total of the plurality of video portions that make up the advertisement, that are of interest to the user. In illustration, a particular advertisement may contain multiple scenes, and the user can provide feedback indicating user interest in one or more of the scenes. Still, a user can express interest in video content in any other suitable manner and the present arrangements are not limited in this regard.

Responsive to receiving user feedback indicating user interest in video content, such as an advertisement, or one or more video portions of the video content, the session manager 144 can create an association between user and the video content, or one or more video portions, that are of interest to the user. The session manager 144 can store such association. In one aspect, the user feedback can indicate a desire by the user to share the association with other people, for example in a social networking service 190. In such case, the session manager 144 can communicate the association to the advertisement sharing engine 170, which will be described herein, and the advertisement sharing engine 170 can create a post in the social networking service 190 corresponding to the association, as will be described.

The advertisement modification engine 150 can include a video content analyzer 152, a content modification analyzer 154, a content preference analyzer 156, a watermarking service 158 and a content modification service 160. The video content analyzer 152 can analyze the video content of video content, such as advertisements and other programming content, to determine which products, actors, offers, etc. are being featured. For example, video content can include metadata, such as data formatted as extensible markup language (XML), which provides information about the video content. When the video content is presented, the video content analyzer 152 can access and process the metadata to form an understanding about the video content. For example, the video content analyzer 152 can access data pertaining to objects that potentially may be presented in the video content, and process the metadata to determine whether objects contained in the video content, for instance one or more products, match any objects contained in the accessed data. Further, the video content analyzer 152 can implement object recognition to recognize objects in the video content, and compare these objects to the accessed data to determine whether any of the recognized match objects contained in the accessed data.

The process of object recognition can be combined into a rule set in the advertisement modification engine 150, session manager 144 or elsewhere in the system 100 and used to determine which objects presented in video content can be modified by a user, for example to change characteristics of the objects or replace the objects with other objects. Based on this information, the session manager 144 can, via the client devices 130-136, prompt users with suggestions as to which objects are available to be modified and/or replaced by the users. For example, if a user is presented an advertisement pertaining to shoes, the user can be provided a prompt alerting the user that the color of shoes can be changed. Moreover, user interface tools/menus can be presented to the user to facilitate such modification. In a further arrangement, the video content analyzer 152 also can identify voices and other sounds in video content, for example using sound recognition algorithms, and a user can be provided options to modify voices, tones, background sounds, etc., or to replace voices or other sounds contained in the video content. Such processes also can be applied to audio content that is not included in video content, for example audio advertisements.

If a user chooses to modify an object, the user's modifications can be stored as metadata associated with the video content. Such metadata can be accessed when it is desired to present the video content with the user's modifications as modified video content. Through the use of metadata at an object level, the system 100 can track user preferences for objects in video content at a granular level. Moreover, users can provide user feedback regarding such objects, as will be described.

The video content analyzer 152 also can receive, via the client devices 130-136, channel publisher(s) 100 and session manager 144, still and/or video image data captured of one or more users using the client device(s) 130-136 while the users are viewing video content that is presented. The video content analyzer 152 can analyze the still/video image data to identify emotive responses of the users. For example, the image data can be analyzed to identify user responses to portions of the video content. In illustration, whether users are laughing, crying, looking away from the video content, etc. can be determined. The image data also can be analyzed to identify a number of users viewing video content on a particular client device 130, estimate ages of the users, etc. Information generated by the video content analyzer 152 based on the analysis of video content, emotive responses of users, etc. can be accessed by the session manager 144 in conjunction with advertisement preferences of users to determine which video content, products, services and/or events within content to which to apply user advertisement preferences. The information also can be provided to the content preference analyzer 156, which will be described, to augment portions of the video content, such as advertisements, to suit preferences of users at a specific time and location. For example, if user feedback indicates a user is not interested in a particular advertisement, other advertisements can be presented in place of that advertisement for the duration of a program or user session. Further, the information generated based on the analysis of emotive responses of users can be provided to advertisers to indicate user reactions, including reactions of an audience group, to their advertisements.

The content modification analyzer 154 can contain a rule set that specifies which parts of video content (e.g., an advertisement or other video content) can be modified, for example by replacing a product with a similar type product, changing colors of a product, adding accessories to a product, changing a voice presented in the video content, or the like. The content modification analyzer 154 can store the rule set based on the format of the video content. Data indicating the format of the video content can be received, for example, from the location service 142. The rule set can be specified by an advertisement provider or other entity. When the user alerts the system that the user desires to modify the video content, the session manager 144 can interact with the content modification analyzer 154 to understand which components of the video content can be modified, and then provide these choices to the user as appropriate. The user can then specify their modification preferences, which can be stored by the content preference analyzer 156.

The content preference analyzer 156 can determine user preferences for video content based on user feedback, such as user inputs and/or emotive responses identified by the video content analyzer 152. For example, the user feedback can indicate like/dislike of video content, indicate a like/dislike of one or more portions of the video content, indicate a like/dislike of one or more items presented in the video content, indicate a preference to skip advertisements or certain advertisements, indicate a preference to view or not view similar advertisements, indicate settings for the display of testimonials received from the user, indicate cues regarding user/audience engagement with video content (e.g., based on detected gestures), indicate selected user preferences, indicate modification preferences, etc. In illustration, based on visibly detected emotive responses and/or gestures of the user, the system can detect who is watching a game and the user/audience response to such video content so that customized advertisements for the user/audience in their given moods can be presented to the user/audience. Moreover, advertisements appropriate to the ages of audience members can be selected for presentation. In one aspect, an advertisement preference can be applied to all following programming content or for the duration of a user session.

The watermarking service 158 can append a user generated testimonial to advertisements, or provide a link in an advertisement to the testimonial. For example, when the user decides to upload his/her testimonial, the watermarking service 158 can initiate insertion of a watermark code into the advertisement at an available timestamp. This watermark code can link to the user's testimonial, which can be resident on the user's own client device 130-136. This testimonial can be accessed by other users viewing the advertisement by setting the preferences for viewing testimonial within the content preference analyzer 156. The advertisement that is watermarked can be communicated to the content modification service 160.

The content modification service 160 can generate final video content by applying the changes to the video content based on information compiled by the video content analyzer 152, content modification analyzer 154 and content preference analyzer 156, and video content received from the watermarking service 158, as well as other information available to the content modification service 160 and/or advertisement modification engine 150. The content modification service 160 can process this information to modify the video content. The content modification service 160 can communicate the modified video content and/or corresponding information to the advertisement sharing engine 170. Further, when a plurality of users are viewing content presented on a particular client device 130, the content modification service 160 can analyze information for each of the users to determine the most optimum video content to deliver to the group of users.

In a further arrangement, the content modification service 160 can, based on user modifications to first video content, modify other video content. For example, if a user changes a color of a vehicle in a first advertisement, the content modification service 160 can apply that change to other advertisements presented to the user for the same vehicle, or to advertisements presented to the user for other vehicles. Further, if the user changes the color of a vehicle in an advertisement presented during a particular program, the content modification service 160 can modify the color of one or more vehicles presented in the program to match the user selected color. For example, the content modification service 160 can change the color of a vehicle driven by a lead character in the program video content to match the user selected color. In this regard, the content modification service 160 can interface with the channel publisher 110 via suitable communication networks/systems to modify the program video content.

The advertisement sharing engine 170 can include an intelligent content service 182 and a packaging service 174. The intelligent content service 182 can communicate to the channel publisher(s) 110 the modified video content, which can stream the modified video content to the client devices 130-136 over a suitable communication medium using an appropriate communication format. Moreover, the channel publisher 110 providing video content to the client device 130 of the user who modified the original video content can communicate the modified video content to the client device 130 as another instance of the video content. The channel publisher 110 also can communicate the modified video content to client devices 132-136 of other users as another instance of the video content, or in place of the original video content.

The packaging service 174 can enable sharing of user interests and modified video content on sites (e.g., websites) of one or more social networking services 190. For example, the packaging service 174 can generate a widget for user interests that enable a user to share a like, dislike or comment about video content or a particular item presented in the video content. The packaging service also can generate a widget that copies/pastes modified video content, or a portion thereof, or a link to the modified video content into a media site of a social networking service 190. A widget can be formatted using a media format, for example Flash®, Dynamic Hypertext Markup Language (HTML) or the like, that enables display of desired shared content. In illustration, the packaging service 174 can receive the modified video content from intelligent content service 182 and repackage it into a sharable widget. Further, the packaging service 174 can receive from the session manager 144 user interests pertaining to advertisements on products, advertisements, etc., and associations between users and their user interests, and repackage the user interests into a widget format that includes the product information and user interest information (e.g., a like, dislike or comment).

Accordingly, these widgets can be shared among users or shared on social media sites. For example, a like, dislike, comment and/or actual portion(s) of the video content or modified content, or a link to such, can be posted in the user's timeline, blog, or the like. In this regard, an association between the user and one or more video portions that are of interest to the user, or a product service or event represented by such video portion(s), can be created in the social networking service 190. Moreover, video content which is modified can be presented to the user or other people with the characteristics as modified by the user. For example, if the user changes the color of a shoe, or changes one product presented in video content to another product, the modified video content can be presented with such changes applied. Moreover, if the user has provided user feedback indicating a like or dislike of a particular item presented in the video content, or a comment about the particular item, the modified video content can be presented with an identifier indicating the particular item and like, dislike or comment. The modified video content can be presented to the user via the client device 130 used by the user to modify the video content, or via another client device 132.

If the user adds a testimonial to the video content, the modified video content can be presented with a link to the testimonial, or the actual testimonial can be embedded in the video content. For example, the testimonial can be presented prior to or after other portions of the video content, or presented during playback of the video content (e.g., as text overlaying the video content, a small window presented over or near a window presenting the video content, etc.). In the case that a link to the testimonial is embedded in the video content (e.g., into one or more portions of the video content), a user can select the link to view or listen to the testimonial.

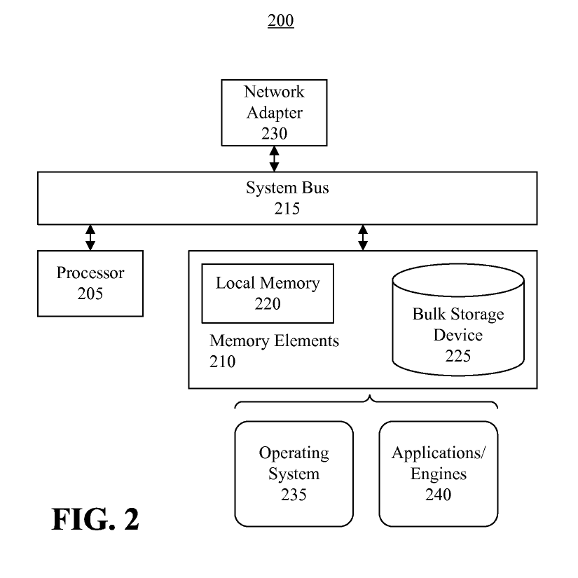

FIG. 2 is a block diagram illustrating example architecture for a data processing system (hereinafter “system”) 200, which may be used as one or more of the servers described herein. The system 200 includes at least one processor 205 coupled to memory elements 210 through a system bus 215 or other suitable circuitry. As such, the system 200 can store program code within the memory elements 210. The processor 205 executes the program code accessed from the memory elements 210 via the system bus 215 or the other suitable circuitry.

In one aspect, the system 200 is implemented as a computer or other programmable data processing apparatus that is suitable for storing and/or executing program code. It should be appreciated, however, that the system 200 can be implemented in the form of any system including a processor and memory that is capable of performing and/or initiating the functions and/or operations described within this disclosure. Further, the system 200 can be implemented in any of a variety of different form factors.

The memory elements 210 include one or more physical memory devices such as, for example, local memory 220 and one or more bulk storage devices 225. Local memory 220 refers to RAM or other non-persistent memory device(s) generally used during actual execution of the program code. Bulk storage device(s) 125 can be implemented as a hard disk drive (HDD), solid state drive (SSD), or other persistent data storage device. The system 200 also can include one or more cache memories (not shown) that provide temporary storage of at least some program code in order to reduce the number of times program code must be retrieved from bulk storage device 225 during execution.

One or more network adapters 230 also can be coupled to the system 200 to enable the system 200 to become coupled to other systems, computer systems, remote printers, and/or remote storage devices through intervening private or public networks. Modems, cable modems, wireless transceivers, and Ethernet cards are examples of different types of network adapters 230 that can be used with the system 200, though the present arrangements are not limited in this regard.

As pictured in FIG. 2, the memory elements 210 can store at least one operating system 235 and one or more applications, and/or engines 240, such as the synchronization engine 140, advertisement modification engine 150 and advertisement sharing engine 170 previously described. The operating system 235 and the one or more applications/engines 240, being implemented in the form of executable program code, can be executed by the system 200 and, as such, can be considered an integrated part of the system 200. Moreover, the operating system 235 and more applications/engines 240, including any parameters and/or attributes utilized by the operating system 235 and more applications/engines 240, are functional data structures that impart functionality when employed as part of the system 200.

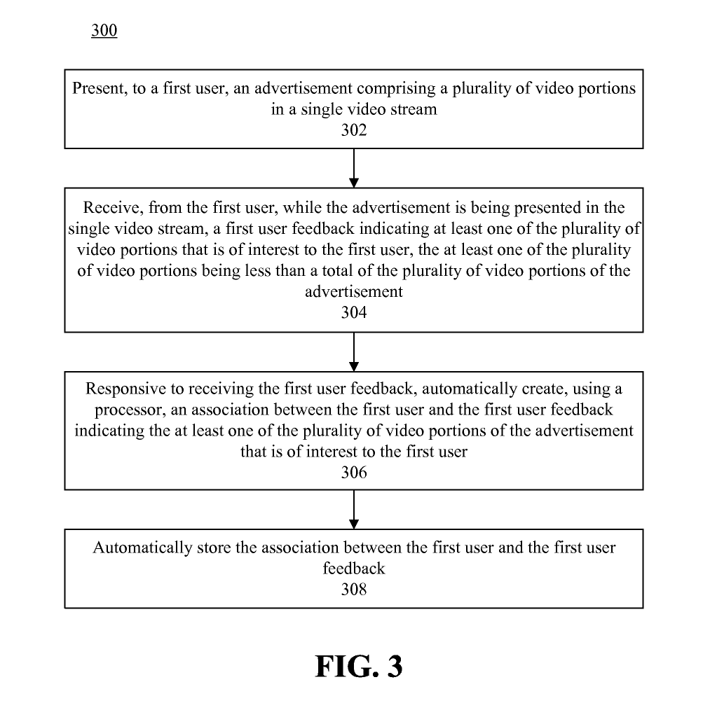

FIG. 3 is a flow chart illustrating an example of a method 300 of creating an association between a user and at least one video portion of an advertisement that is of interest to the user. At step 302, an advertisement comprising a plurality of video portions in a single video stream can be presented to a first user. At step 304, a first user feedback can be received from the first user while the advertisement is being presented in the single video stream. The first user feedback can indicate at least one of the plurality of video portions that is of interest to the first user, the at least one of the plurality of video portions being less than a total of the plurality of video portions of the advertisement. In one arrangement, the at least one video portion can present a particular product, service or event.

At step 306, responsive to receiving the first user feedback, an association between the first user and the first user feedback, which indicates the at least one of the plurality of video portions of the advertisement that is of interest to the first user, can be automatically created using a processor. In illustration, an association between the first user and the at least one of the plurality of video portions that is of interest to the first user can be created in a social networking service. For example, an association between the first user and the product, service or event presented in the video portion(s) can be created in the social networking service. At step 308, the association between the first user and the first user feedback can be automatically stored. For example, the association can be stored locally and/or in the social networking service.

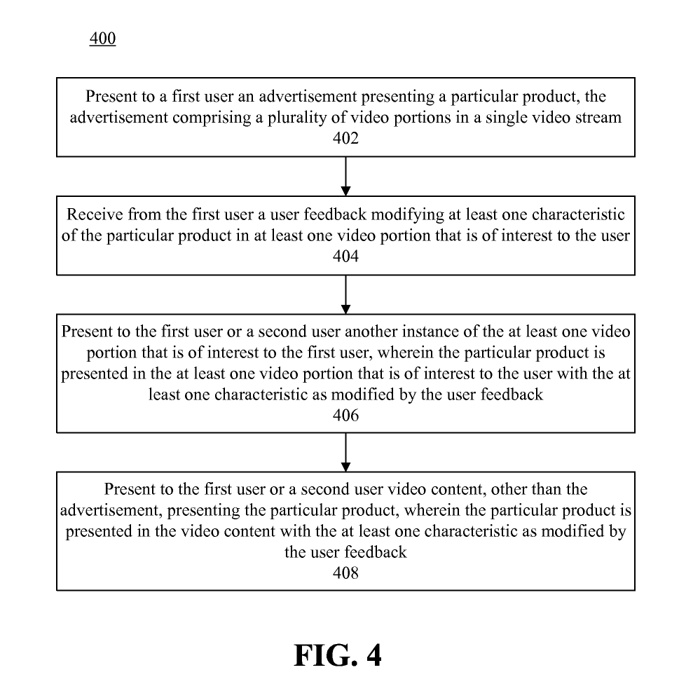

FIG. 4 is a flow chart illustrating an example of a method 400 of modifying a characteristic of a product in at least one video portion of an advertisement that is of interest to the user. At step 402, an advertisement presenting a particular product can be presented to a first user, the advertisement comprising a plurality of video portions in a single video stream. At step 404, a user feedback modifying at least one characteristic of the particular product in at least one video portion that is of interest to the user can be received from the user.

At step 406, another instance of the at least one video portion that is of interest to the first user can be presented to the first user or a second user, wherein the particular product is presented in the at least one video portion that is of interest to the user with the at least one characteristic as modified by the user feedback. At step 408, video content, other than the advertisement, can be presented to the first user or a second user. The video content can present the particular product, wherein the particular product is presented in the video content with the at least one characteristic as modified by the user feedback. At this point it should be noted that steps 406 and 408 are dependent on one another. For example, step 406 can be implemented without implementing step 408, and step 408 can be implemented without implementing step 406.

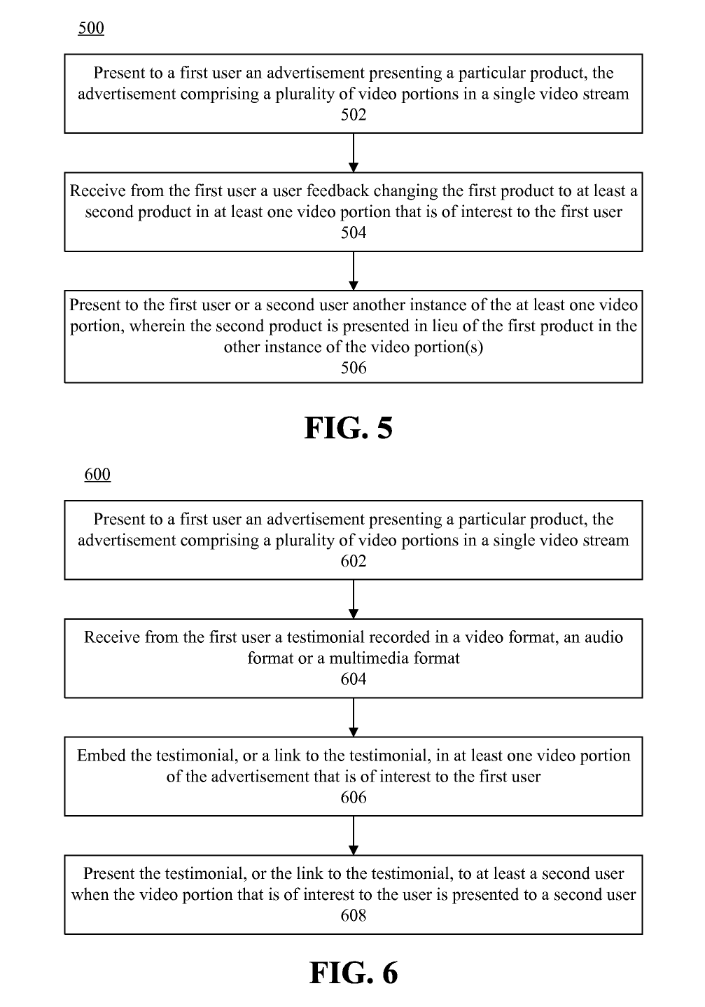

FIG. 5 is a flow chart illustrating another example of a method 500 of modifying a characteristic of a product in at least one video portion of an advertisement that is of interest to the user. At step 502, an advertisement presenting a particular product can be presented to a first user, the advertisement comprising a plurality of video portions in a single video stream. At step 504, a user feedback can be received from the first user changing the first product to at least a second product in at least one video portion that is of interest to the first user. At step 506, another instance of the at least one video portion can be presented to the first user or a second user, wherein the second product is presented in lieu of the first product in the other instance of the video portion(s).

FIG. 6 is a flow chart illustrating an example of a method 600 of embedding a testimonial, or a link to the testimonial, in at least one video portion of an advertisement that is of interest to the user. At step 602, an advertisement presenting a particular product can be presented to a first user, the advertisement comprising a plurality of video portions in a single video stream. At step 604, a testimonial recorded in a video format, an audio format or a multimedia format can be received from the first user. At step 606, the testimonial, or a link to the testimonial, can be embedded in at least one video portion of the advertisement that is of interest to the user. At step 608, the testimonial, or the link to the testimonial, can be presented to a second user when the video portion that is of interest to the user is presented to a second user. In the case that the link is provided, responsive to the second user selecting the link to the testimonial, the testimonial can be presented to the second user.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
presenting, to a first user, an advertisement comprising a plurality of video portions in a single video stream;
receiving, from the first user, while the advertisement is being presented in the single video stream, a first user feedback indicating at least one of the plurality of video portions that is of interest to the first user, the at least one of the plurality of video portions being less than a total of the plurality of video portions of the advertisement;
responsive to receiving the first user feedback, automatically creating, using a processor, an association between the first user and the first user feedback indicating the at least one of the plurality of video portions of the advertisement that is of interest to the first user; and
automatically storing the association between the first user and the first user feedback.

2. The method of claim 1, wherein creating the association between the first user and the first user feedback indicating the at least one of the plurality of video portions that is of interest to the first user comprises:
creating an association between the first user and the at least one of the plurality of video portions that is of interest to the first user in a social networking service.

3. The method of claim 1, wherein:
the at least one of the plurality of video portions that is of interest to the first user presents a particular product, service or event; and
creating the association between the first user and the first user feedback indicating the at least one of the plurality of video portions that is of interest to the first user comprises creating an association between the first user and the product, service or event in a social networking service.

4. The method of claim 1, wherein the at least one of the plurality of video portions that is of interest to the first user presents a particular product, the method further comprising:
receiving from the first user a second user feedback modifying at least one characteristic of the particular product; and
presenting to the first user or a second user video content, other than the advertisement, presenting the particular product, wherein the particular product is presented in the video content with the at least one characteristic as modified by the second user feedback.

5. The method of claim 1, wherein the at least one of the plurality of video portions that is of interest to the first user presents a particular product, the method further comprising:
receiving from the first user a second user feedback modifying at least one characteristic of the particular product in the at least one of the plurality of video portions that is of interest to the first user; and
presenting to the first user or a second user another instance of the at least one of the plurality of video portions that is of interest to the first user, wherein the particular product is presented in the other instance of the at least one of the plurality of video portions that is of interest to the first user with the at least one characteristic as modified by the second user feedback.

6. The method of claim 1, wherein the at least one of the plurality of video portions that is of interest to the first user presents a first product, the method further comprising:
receiving from the first user a second user feedback changing the first product to at least a second product in the at least one of the plurality of video portions that is of interest to the first user; and
presenting to the first user or a second user another instance of the at least one of the plurality of video portions that is of interest to the first user, wherein the second product is presented in lieu of the first product in the other instance of the at least one of the plurality of video portions that is of interest to the first user.

7. The method of claim 1, further comprising:
receiving from the first user a testimonial recorded in a content format selected from a group consisting of a video format, an audio format and a multimedia format;
embedding the testimonial in the at least one of the plurality of video portions that is of interest to the first user; and
presenting the testimonial to at least a second user when the at least one of the plurality of video portions that is of interest to the first user is presented to a second user.

8. The method of claim 1, further comprising:
receiving from the first user a testimonial recorded in a content format selected from a group consisting of a video format, an audio format and a multimedia format;
embedding a link to the testimonial in the at least one of the plurality of video portions that is of interest to the first user;
presenting to at least a second user another instance of the at least one of the plurality of video portions that is of interest to the first user; and
responsive to the second user selecting the link to the testimonial, presenting the testimonial to the second user.

9. A system, comprising:
a processor programmed to initiate executable operations comprising:
presenting, to a first user, an advertisement comprising a plurality of video portions in a single video stream;
receiving, from the first user, while the advertisement is being presented in the single video stream, a first user feedback indicating at least one of the plurality of video portions that is of interest to the first user, the at least one of the plurality of video portions being less than a total of the plurality of video portions of the advertisement;
responsive to receiving the first user feedback, automatically creating an association between the first user and the first user feedback indicating the at least one of the plurality of video portions of the advertisement that is of interest to the first user; and
automatically storing the association between the first user and the first user feedback.

10. The system of claim 9, wherein creating the association between the first user and the first user feedback indicating the at least one of the plurality of video portions that is of interest to the first user comprises:
creating an association between the first user and the at least one of the plurality of video portions that is of interest to the first user in a social networking service.

11. The system of claim 9, wherein:
the at least one of the plurality of video portions that is of interest to the first user presents a particular product, service or event; and
creating the association between the first user and the first user feedback indicating the at least one of the plurality of video portions that is of interest to the first user comprises creating an association between the first user and the product, service or event in a social networking service.

12. The system of claim 9, wherein the at least one of the plurality of video portions that is of interest to the first user presents a particular product, the executable operations further comprising:
receiving from the first user a second user feedback modifying at least one characteristic of the particular product; and
presenting to the first user or a second user video content, other than the advertisement, presenting the particular product, wherein the particular product is presented in the video content with the at least one characteristic as modified by the second user feedback.

13. The system of claim 9, wherein the at least one of the plurality of video portions that is of interest to the first user presents a particular product, the executable operations further comprising:
receiving from the first user a second user feedback modifying at least one characteristic of the particular product in the at least one of the plurality of video portions that is of interest to the first user; and
presenting to the first user or a second user another instance of the at least one of the plurality of video portions that is of interest to the first user, wherein the particular product is presented in the other instance of the at least one of the plurality of video portions that is of interest to the first user with the at least one characteristic as modified by the second user feedback.

14. The system of claim 9, wherein the at least one of the plurality of video portions that is of interest to the first user presents a first product, the executable operations further comprising:
receiving from the first user a second user feedback changing the first product to at least a second product in the at least one of the plurality of video portions that is of interest to the first user; and
presenting to the first user or a second user another instance of the at least one of the plurality of video portions that is of interest to the first user, wherein the second product is presented in lieu of the first product in the other instance of the at least one of the plurality of video portions that is of interest to the first user.

15. The system of claim 9, the executable operations further comprising:
receiving from the first user a testimonial recorded in a content format selected from a group consisting of a video format, an audio format and a multimedia format;
embedding the testimonial in the at least one of the plurality of video portions that is of interest to the first user; and
presenting the testimonial to at least a second user when the at least one of the plurality of video portions that is of interest to the first user is presented to a second user.

16. The system of claim 9, the executable operations further comprising:
receiving from the first user a testimonial recorded in a content format selected from a group consisting of a video format, an audio format and a multimedia format;
embedding a link to the testimonial in the at least one of the plurality of video portions that is of interest to the first user;
presenting to at least a second user another instance of the at least one of the plurality of video portions that is of interest to the first user; and
responsive to the second user selecting the link to the testimonial, presenting the testimonial to the second user.

17. A computer program product comprising a computer readable storage medium having program code stored thereon, the program code executable by a processor to perform a method comprising:
presenting to a first user, by the processor, an advertisement comprising a plurality of video portions in a single video stream;
receiving, by the processor, from the first user, while the advertisement is being presented in the single video stream, a first user feedback indicating at least one of the plurality of video portions that is of interest to the first user, the at least one of the plurality of video portions being less than a total of the plurality of video portions of the advertisement;
responsive to receiving the first user feedback, automatically creating, by the processor, an association between the first user and the first user feedback indicating the at least one of the plurality of video portions of the advertisement that is of interest to the first user; and
automatically storing, by the processor, the association between the first user and the first user feedback.

18. The computer program product of claim 17, wherein creating the association between the first user and the first user feedback indicating the at least one of the plurality of video portions that is of interest to the first user comprises:
creating an association between the first user and the at least one of the plurality of video portions that is of interest to the first user in a social networking service.

19. The computer program product of claim 17, wherein the at least one of the plurality of video portions that is of interest to the first user presents a particular product, the method further comprising:
receiving, by the processor, from the first user a second user feedback modifying at least one characteristic of the particular product; and
presenting, by the processor, to the first user or a second user video content, other than the advertisement, presenting the particular product, wherein the particular product is presented in the video content with the at least one characteristic as modified by the second user feedback.

20. The computer program product of claim 17, wherein the at least one of the plurality of video portions that is of interest to the first user presents a particular product, the method further comprising:
receiving from the first user a second user, by the processor, feedback modifying at least one characteristic of the particular product in the at least one of the plurality of video portions that is of interest to the first user; and
presenting to the first user or a second user, by the processor, another instance of the at least one of the plurality of video portions that is of interest to the first user, wherein the particular product is presented in the other instance of the at least one of the plurality of video portions that is of interest to the first user with the at least one characteristic as modified by the second user feedback.
